(19) United States
(12) Patent Application Publication
(10) Pub. No.: US 2011/0211110 A1
(43) Pub. Date: Sep. 1, 2011

(54) A METHOD AND AN INTERACTIVE SYSTEM FOR CONTROLLING LIGHTING AND/OR PLAYING BACK IMAGES

(76) Inventor: Antoine Doublet, Paris (FR)

(21) Appl. No.: 12/933,003

(22) PCT Filed: Mar. 17, 2009
(86) PCT No.: PCT/FR2009/050446

§ 371 Date: May 10, 2011

(30) Foreign Application Priority Data
Mar. 17, 2008 (FR) 0851719

(51) Int. Cl. H04N 5/225

(52) U.S. Cl. 348/370

(57) ABSTRACT

The present invention relates to an interactive system (1) for controlling lighting and/or image playback, the system comprising:
at least one image acquisition device, in particular a video camera (2);
a base module (3) configured to receive and analyze information from the image acquisition device (2) in order to detect the presence of at least one person (P) in the field of the image acquisition device; and
at least one control module (4) configured to receive a control signal coming from the base module (3) and, as a function of said control signal, to control the intensity and/or the orientation of at least one light source (5) and/or at least one played-back visual content, in order to comply with a predefined lighting relationship.

The present invention relates to an interactive system for controlling lighting and/or playing back images, and also to a method of modifying the lighting ambiance in a space.

WO 00/75417 discloses an intelligent floor provided with sensors that serve to detect changes, and making it possible, for example, to light a room when a person enters it and to switch off the light when the last occupant leaves the room.

A drawback of such a system is that it cannot be installed easily in an existing dwelling.

Spotlights are also known that are fitted with a movement sensor and with an ambient lighting sensor in order to light a space when movement is detected therein. Such spotlights are generally reserved for use outside dwellings and they merely indicate the presence of a person in a zone and not the position of that person.

When a room is illuminated by a plurality of light sources, e.g. by one or more chandeliers, one or more wall fittings, and/or one or more lamps fitted with shades, each light source provides light in its own particular manner in a corresponding portion of the room, and depending on where people are located in said room, the best lighting often corresponds to some particular combination of the light sources being switched on. This best combination varies over the day as a function of the light level due to natural light.

There exists a need to improve existing lighting in particular so as to light a space in satisfactory manner while taking account of the specific features of the various light sources, their disposition, and the locations of people in the space.

There also exists a need to create light ambiances in a space.

### Interactive System

Amongst other things, in a first of its aspects, the invention seeks to satisfy these needs.

The invention achieves by means of an interactive system for controlling lighting and/or image playback, the system comprising:
at least one image acquisition device, in particular a video camera;
a base module configured to receive and analyze information from the image acquisition device in order to detect the presence of at least one person in the field of the image acquisition device; and
at least one control module configured to receive a control signal coming from the base module and, as a function of said control signal, to control the intensity and/or the orientation of at least one light source and/or at least one played-back visual content, e.g. selected from predefined images or image sequences, in order to comply with a predefined lighting relationship.

By means of the invention, the lighting of the space associated with the system may be performed automatically as a function of the specific features of the various light sources, of the positions of people in said space, and of the light level due to natural light.

The invention makes it possible to avoid installing sensors in the floor.

### Interactive System and Base Module

The base module may be configured to receive and analyze information coming from an image acquisition device in order to detect the lighting level of at least one zone in the field of the image acquisition device, e.g. in order to control the light level of the or each light source.

This makes it possible to achieve relatively accurate control of the lighting, in a manner that matches needs.

The base module may be configured to respond to the information coming from the image acquisition device to determine the spatial coordinates of a person in the field of the image acquisition device in two dimensions (x,y), or indeed in three dimensions (x,y,z) where there are two image acquisition devices. This may make it possible to control the various light sources as a function of these spatial coordinates so as to provide best lighting for the people situated in the space associated with the interactive system of the invention. For example, the interactive system may determine that only certain light sources are required to light the room with light intensity above some predefined threshold, whereas other light sources may be switched off or may light the room at an intensity that is below the given threshold, so as to create relatively diffuse ambient lighting.

The invention makes it possible to provide a degree of light comfort while also enabling energy to be saved by avoiding over-lighting or pointlessly lighting the space that is associated with the interactive system.

The invention may also enable the activity of people in the room to be taken into account in order to determine the corresponding optimum lighting. For example, the interactive system may detect that a person is in the room but is not moving, which may correspond for example to a person who is seated, e.g. reading. Under such circumstances, the interactive system may reduce the intensity of light sources that are far away from that person. The interactive system may also detect that a person is frequently changing place within a room, and under such circumstances it may maintain a relatively high level of diffuse lighting throughout the room so as to avoid changing the lighting in the room too frequently. The system may also determine that one or more people are static in front of a video screen that is in operation, and may then modify the ambient lighting level.

As a function of where people are located, the interactive system may also create entertainment in the zone(s) where they are situated by causing images or image sequences to be played back. The base module may be configured, at least on the first occasion the system is put into operation, to cause each of the light sources to be switched on in succession and to record the spatial distribution of the light intensity produced by each of them. In order to control successive switching on of the light sources, the base module may for example send successive control signals to each control module.

Thus, the interactive system can determine which light sources to switch on and what intensities they should deliver to light a region of the space associated with the interactive system in optimum manner.

The invention makes it possible to take account of the specific features of different light sources. The stage during which the interactive system is being trained may take place when the space is not receiving any natural light, e.g. at night or behind closed shutters. This gives greater accuracy to the measurement of the way light from each light source is spatially distributed. A table of the different light sources may be stored by the interactive system, with each light source being associated with the spatial distribution and the light intensity provided in the field of observation of the image acquisition device.

The modification of the lighting may result solely in the light sources being switched on or off, and/or in the light intensity delivered by each source being varied progressively.

The modification of the lighting may also result in a modification to the orientation of at least one light source, if it is motor-driven.

An image processor may be incorporated in the image acquisition device or in the base module, for example.

The interactive system may be arranged to detect movement, to locate people in the field of observation covered by the camera, to measure light intensity. The interactive system may also be arranged, where appropriate, to recognize shapes, e.g. for the purpose of distinguishing between animals or people, or to recognize faces, thus enabling the interactive system to perform other functions, e.g. to identify people at least to some extent and detect intrusions. The system may in particular detect that a face is facing towards a light source in order to reduce the intensity of that source and reduce the risk of dazzle.

The interactive system may include at least one sensor other than the video camera, for example an infrared presence sensor (a pyroelectric sensor) or a light sensor using a photoelectric cell. The base module may be configured to process at least some information coming from such an additional sensor. The use of a pyroelectric sensor may for example serve to trigger the operation of the system starting from a standby state in which none of the lighting is on.

The base module may receive information from a user, which information may be communicated to the base module by the user via a control keypad, a wireless remote control, or a computer, in particular by means of a suitable program including a user interface. The base module may for example include an interface enabling it to communicate by radio, by power line carrier (PLC) or by an Ethernet or RS232 or other connection, e.g. in order to enable the user to view the images and to program the way the interactive system is to respond as a function of the images observed.

The interactive system may also be made in such a manner as to operate in completely independent manner without requiring any programming by the user, or programming may be reduced to a minimum, e.g. in order to inform the base module of the existence of remote control modules connected to light sources, or to start a training system, or to perform a reset.

### Light Source(s)

The or each light source may be selected from halogen lamps, incandescent bulbs, light-emitting diodes (LEDs) or the like (organic LEDs (OLEDs), . . . ), fluorescent lamps, and devices for projecting images, in particular with a liquid-crystal display (LCD), a plasma display, a cathode ray tube, back projectors, video projectors, . . . .

Thus, the lighting of the space associated with the interactive system may come at least in part from luminous images displayed on video screens or projected onto various media, e.g. by means of projectors optionally provided with focusing devices, devices for adjusting beam divergence, or colored filters. The lighting may also come from video projectors. It is possible to use video screens or video projectors as light sources. When the lighting is provided at least in part by luminous images, they may be static or moving, and optionally predefined. For example, the interactive system may be arranged to measure the lighting associated with switching on a TV or a computer screen, and may optionally correct the level of lighting from other light sources in order to take account thereof. For example, the interactive system may detect that a video screen has been switched on and it may be programmed to lower the level of lighting from other light sources after detecting the presence of a person facing the video screen. The interactive system may be arranged to detect the presence and the position of a person, for example, and to project images as a function of the position of that person, so as to create local features of interest. This may be useful for example for issuing an advertising message in a shop, in a shop window, or in the street.

The interactive system may include a luminaire, e.g. a chandelier, including the video camera, the base module, at least one control module, and at least one light source. The interactive system may comprise solely the luminaire or it may also comprise other control modules that are not incorporated in the luminaire, serving to control remote light sources, these other control modules being, for example, plugged in to power outlets or incorporated in an electric control panel.

The luminaire may have a plurality of directional light sources and at least one diffuse light source. By way of example, the interactive system is arranged to switch on the directional light sources with intensities that are variable as a function of the information provided by the camera in order to provide lighting in the direction where presence has been detected. The intensity level of the diffuse lighting from the diffuse light source may be constant or variable, e.g. as a function of the ambient lighting level associated with natural light. The diffuse lighting may be controlled by a wall switch, where appropriate.

The level of diffuse lighting may be controlled as a function of the activity of people as determined by the base module. The ratio of spot lighting level to diffuse lighting level may also depend on the activity of the people as determined in this way. For example, when people are moving about in the space associated with the system, the level of diffuse lighting may be higher than when the people are static.

### Image Acquisition Device

The image acquisition device may comprise a video camera.

The video camera may have infrared vision.

Where appropriate, the interactive system may include a pyroelectric sensor, as mentioned above. The video camera may be connected to the base module by a wired or wireless connection. The video camera may be connected by a composite video output to the base module. In a variant, the video camera is incorporated in the base module. The video camera may be monochrome or color. By way of example, its resolution may be at least about 2 megapixels. The video camera may optionally be motorized. It may include a microphone and an audio output that may be used to confirm a presence, for example, or that may be useful for enabling lighting to be controlled by voice with the help of an audio recognition program.

The video camera may include a wide-angle lens, for example it may be arranged to observe over 360°, e.g. a lens of the dome type or some other type, e.g. a standard camera with a wide-angle lens.

When it is arranged to observe over 360°, the camera may for example be oriented with its axis of observation extending vertically downwards, e.g. with the camera passing to the ceiling, either directly or via a luminaire in which it is incorporated.

The interactive system of the invention may include a plurality of video cameras, in particular two of them, with it being possible for the base module to be configured to receive at least some information from each camera. Each video camera may cover only a portion of the space associated with the interactive system. The observation fields of the various cameras may optionally overlap.

### Control Module(s)

The control module may include a dimmer so as to modify the intensity of at least one light source. By way of example, the dimmer may be arranged to generate a level of lighting that is coded on at least four bits (e.g. having 22 levels).

The control module may also be configured to modify the orientation of at least one light source. Under such circumstances, the control module may include at least one hinge connected to a light source and a motor suitable for modifying the orientation of the light source. By way of example, the interactive system may serve to point the light source of adjustable orientation towards the zone occupied by the person whose presence has been detected.

When remote, the control module may communicate with the base module via a link selected from: optionally wired connections, PLC, e.g. of the X10 type, or by radio (WiFi, Bluetooth, Wimax).

### Predefined Lighting Relationship

The interactive system may include a memory in which a predefined lighting relationship is stored. By way of example, this relationship may seek to ensure a predefined lighting level, e.g. greater than a given threshold, in a zone where the presence of a person has been detected. This threshold may optionally be adjusted by the user, e.g. using a potentiometer or other adjustment means present on the base module, or by means of a remote control, or by means of a terminal that communicates with the base module.

Where appropriate, a plurality of predefined lighting relationships may be prerecorded in the base module and the user may select one of them as a function of the desired ambiance, for example.

In another variant, the predefined lighting relationship may be downloaded from a server while the system is in use, in particular when the system is capable of communicating over the Internet, e.g. via a WiFi connection or the like.

The predefined lighting relationship may respond to the ratio between the level of lighting coming from directional light sources and the level of lighting coming from light sources that provide diffuse lighting, e.g. as a function of determining the activity of the person or people, as a result of analyzing their movements.

### Methods

Independently or in combination with the above, in another of its aspects the present invention also provides a method of automatically modifying the lighting or light ambient in a space that includes at least one light source for lighting it at least in part, the method comprising the steps consisting in:
acquiring at least one image of at least a portion of said space suitable for being lighted by said at least one light source;
analyzing said image to detect the presence of at least one person and optionally to measure the light level in said space; and
as a function of the analysis as performed in this way, controlling the light source so as to comply with a predefined lighting relationship.

The term “automatically” is used to mean without human intervention, e.g. using an interactive system as defined above.

Independently or in combination with the above, the present invention also provides a method of initializing the interactive system as defined above, used in association with a space including at least one light source the method comprising the following steps:

a) installing the system;

b) switching on a light source;

c) using the image acquisition device, in particular the video camera, to determine the incidence on the light level of the space or switching on said light source, and storing corresponding information; and

d) reiterating steps b) and c) for any other light sources, where appropriate.

When at least one control module is configured to modify the orientation of a light source, the initialization method may also include the steps consisting in modifying the orientation of the light source and of receiving and storing at least some information coming from the video camera relating to the lighting of the space as a function of the orientation of the light source. Under such circumstances, the method may include steps consisting in reiterating the above-mentioned steps for a given light source, so as to store the different lighting configurations obtained with the different orientations of a given light source.

Stage a) of initializing the system may comprise steps consisting in placing the system in the associated space so as to enable the video camera to observe at least one zone of said space, and connecting the system to the power network. Stage a) may also include the step consisting in connecting control modules to the power network, the light sources being connected to the control module. For example, at least some of the control modules may be arranged to receive PLC signals and may comprise units including a male plug for plugging into a wall outlet and a female outlet for receiving the male plug of a light source.

The initialization method may be implemented automatically, e.g. at regular time intervals, in particular at night, so as to update the characteristics of the various light sources, for example.

The system may be arranged to control some maximum number n of remote light sources by means of corresponding control modules.

The interactive system may send a control signal sequentially to the addresses of those n control modules and determine whether a change of lighting occurs in response to sending a control signal. If there is no change, then the system deduces that the control module associated with that address does not exist.

Independently or in combination with the above, in another of its aspects, the present invention also provides an automatic method of controlling the playing back of images, the method comprising the steps consisting in:
acquiring at least some information relating to the presence and/or activity of at least one person in a zone by using at least one image acquisition device such as a video camera, the zone possibly corresponding to the field of observation of the image acquisition device, in particular the video camera;
analyzing said information; and
as a function of said information, controlling the playing back of images on a predefined medium, in application of a predefined image playback relationship.

Such a method may be useful for creating a feature of interest in a shop window, for example, with different images being projected depending on the locations and/or activity of people outside the window.

The information relating to the presence of at least one person may comprise information relating to the identity of the person, it being possible for the system to perform face recognition, for example. Under such circumstances, the image playback relationship, in particular the choice of images to play back and/or of the medium on which they are to be projected may be a function of the identity or the size of the person.

By way of example, the interactive system may play back different images depending on whether the observer of a scene or of a shop window is recognized as being an adult or a child. This may make it possible to create specific features of interest on a scene or in a shop window, for example.

### OTHER EMBODIMENTS

Independently of the above, in another of its aspects, the invention provides an interactive system for lighting an object, e.g. an object in a shop window, in a showcase, or in a museum, the interactive system comprising:
one or more light sources lighting the object;
a camera having its field of view directed in a direction away from the object; and
a data processor system for processing the data coming from the camera and for controlling the light source(s);

the processor system being arranged to modify the lighting delivered by the light source(s) as a function of detecting at least a portion of the face of a person in the field of observation of the camera.

Such an interactive system advantageously makes it possible to provide a feature of interest in a shop window so as to increase its attractiveness, and may also enable energy savings to be made by not lighting the shop window in the absence of any observer.

Furthermore, the object righted by the light source(s) may be an exhibit in a museum.

The modification to the lighting may comprise:
switching on or off the light source(s) controlled by the interactive system; and/or
changing the color of the light source(s); and/or
increasing or decreasing the intensity of light provided by one or more of the light sources.

Lighting may be switched on or off or progressively, e.g. with light intensity varying progressively whenever a light source is switched on and/or off.

By way of example the observed object may be a museum exhibit that might be the subject of constraints concerning a total maximum amount of lighting that must not be exceeded in order to avoid damaging the exhibit.

The invention makes it possible to reduce the lighting of such an object as much as possible and to avoid any pointless lighting thereof, such that the object may be exhibited to the public for a greater length of time without fear of exceeding the maximum acceptable accumulated dose of light, since the object is lighted only while it is being observed.

Where appropriate, the analysis of the image from the camera may serve to detect not only the presence of a face of at least one person in the field of observation of the camera, but also the direction in which the person is facing, e.g. the gaze direction of the person, thus making it possible to further reduce any risk of pointlessly modifying the lighting of the object.

The interactive system may be configured in such a manner as to modify the lighting of at least two light sources in different manners as a function of the direction as detected in this way. For example, the intensity may be increased in the zone that is being observed by the detected face.

Where appropriate, the interactive system may be arranged to cause audiovisual content to be played back as well as modifying lighting, the audiovisual content possibly relating to the observed object, for example it may comprise a commentary about the object when it is a museum exhibit or it may be advertising when the object is for sale and is on display in a shop window.

The camera may be hidden from the observers of the object, in particular they may be placed behind a semi-reflective surface.

When the interactive system is for placing in a museum, the interactive system may include a meter for metering the duration of lighting, in particular when the object is a museum exhibit that is the subject of a maximum duration of exposure to light.

The interactive system may lack any bulk storage means for storing the images picked up by the camera and may lack any means for sending said images to a server. The term “bulk storage means” should be understood as designating any memory capable of storing several megabytes or gigabytes of data, e.g. SD type memory cards or other flash memories, hard disks, magnetic tapes, or optical disks.

Thus, the interactive system does not store in memory the images of the faces that have observed the object.

The interactive system may advantageously be incorporated in a fitting for lighting the object, e.g. a wall fitting, said fitting including for example a support for fastening it to the wall together with one or more arms carrying one or more light sources, the camera possibly being secured to one of the arms, and the processor system possibly being located in the support for fastening to the wall or in a housing supported by one of the above-mentioned arms, for example.

The camera may be a camera that observes in visible light or in infrared light.

In another of its aspects, the invention also provides a method of automatically modifying the lighting of an object lighted by at least one light source, in particular an object in a shop window, in a showcase, or in a museum, the method comprising the following steps:
acquiring an image by means of a camera having its field of view directed in a direction away from the object;
detecting in the acquired image at least a portion of the face of a person; and
modifying the lighting of the source(s) as a function of the detection performed in the preceding step.

The modification of the lighting may comprise:
switching on or off the light source(s); and/or
changing the color of the light source(s); and/or
increasing or reducing the intensity of light coming from one or more of the light sources.

The method may include the step whereby the orientation of the face of a person is detected.

An audiovisual content may be delivered in addition to modifying the lighting, which audiovisual content may relate to the observed object, for example.

The method may be devoid of any step whereby the images picked up by the camera are stored in bulk storage means or any step whereby said images are sent to a server.

The invention can be better understood on reading the following description of non-limiting embodiments thereof, and on examining the accompanying drawings, in which:

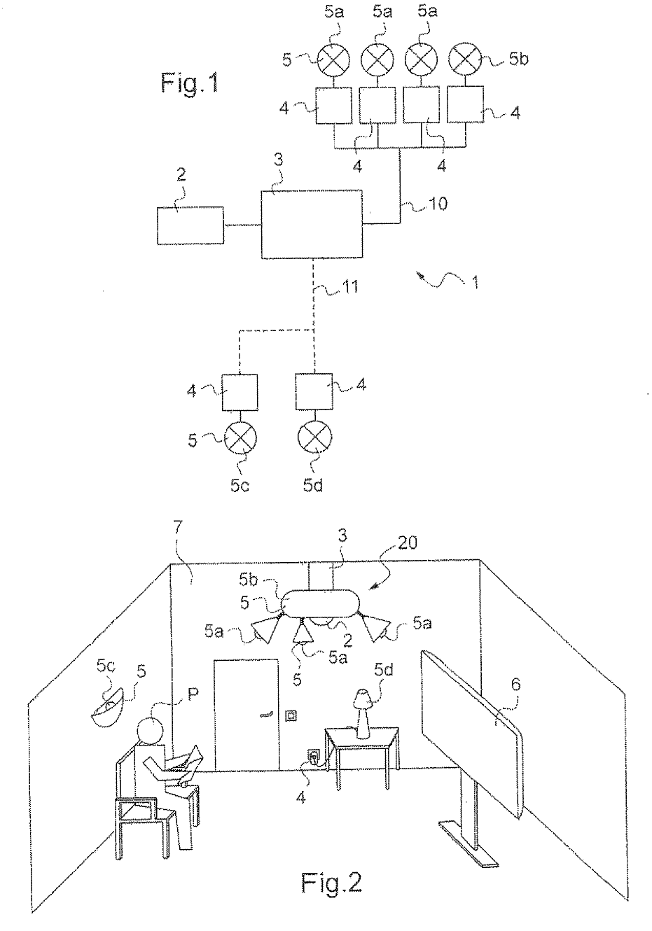

FIG. 1 is a diagram of an example of an interactive lighting control system of the invention;

FIG. 2 is a diagrammatic and fragmentary view in perspective of a space fitted with an interactive accordance with the invention;

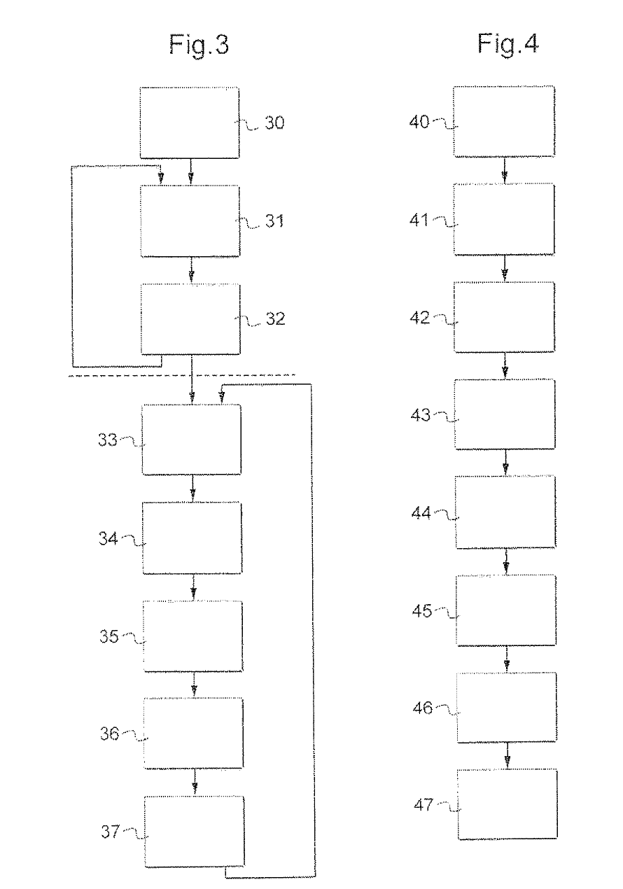

FIG. 3 is a block diagram for explaining the operation of the interactive system of FIG. 1;

FIG. 4 is a block diagram for explaining one example of analysis and determination of a predefined lighting relationship;

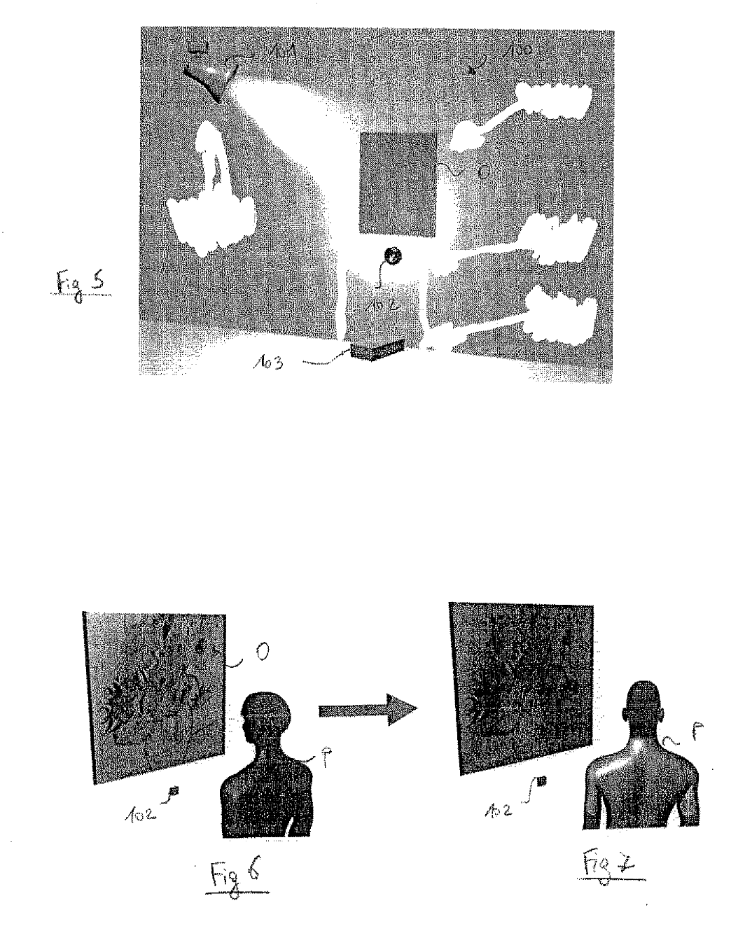

FIG. 5 is a diagram of an example of the interactive system for lighting an object in another aspect of the invention; and

FIGS. 6 and 7 show the modification performed by the interactive system for lighting the object as a result of detecting the person's face.

FIG. 1 shows an interactive lighting control system 1 comprising an image acquisition device itself comprising a video camera 2 in the example shown, and a base module 3 configured to receive and analyze information coming from the video camera 2, e.g. in order to detect the presence, and better the position, of at least one person P in the field of the video camera 2, and optionally also the lighting level in at least one zone of the field of the video camera 2.

The drawing shows a single video camera, however the system of the invention may have a plurality of cameras without going beyond the ambit of the invention. Under such circumstances, each video camera may be configured to send at least some corresponding information to the base module 3. When there are several video cameras, the base module may be configured to determine spatial coordinates in three-dimensions (x,y,z) of a person in the field of the video cameras as a function of the information delivered by the video cameras.

The interactive system 1 also has a plurality of control modules 4, each configured to receive a control signal coming from the base module 3.

The control module(s) 4 are also configured to respond to said control signal to control the intensity and/or the orientation of at least one associated light source 5. The number of light sources connected to the interactive system 1 is preferably greater than one. Each control module 4 may be connected to one or more light sources.

Each control module 4 may include an electric switch such as a relay, or better a semiconductor switch, e.g. a triac or transistor switch, or an insulated gate bipolar transistor (IGBT).

Each control module 4 advantageously makes it possible to adjust light intensity progressively, e.g. by varying a on-duration/off-duration mark-space ratio. By way of example, level adjustment may be binary (on or off) or gradual, e.g. being coded on at least four bits.

Each control module 4 may include its own electrical power supply, e.g. by a connection to the 110 volts (V) or 220 V power network.

The base module 3 may communicate with the or each control module 4 via various types of connection, e.g. as shown by a direct wired connection 10, or by an indirect connection 11, e.g. by PLC as shown, or indeed by a radio frequency (RF) connection, e.g. in the bands around 400 megahertz (MHz), around 800 MHz, or around 2 gigahertz (GHz).

The video camera 2 may be a dome type wide-angle camera or a camera of some other type, e.g. a standard camera with a wide-angle lens.

The base module 3 is configured to receive and analyze the video signal coming from the video camera 2 in order to detect the presence and/or movements of one or more people present in the field of the video camera and optionally to measure the light intensity in the field of the video camera.

The base module 3 may be configured to receive not only the signal coming from the video camera, but also information coming from other sensors such as one or more presence or light level sensors, for example. The interactive system may advantageously have no additional sensor, thereby simplifying implementation thereof, or may have as its only additional sensor a pyroelectric sensor.

The base module 3 includes a memory for storing data relating to the light level as produced by each of the light sources.

FIG. 2 shows an example of a space 7 having various light sources that are controlled by the interactive system 1. The space 7 is visible as a whole in the field of vision of the video camera 2, which in the example shown has a lens giving it 360° vision.

The video camera 2 and the base module 3 may be incorporated in a chandelier 20 as shown. The chandelier 20 may also incorporate light sources 5 connected to control modules, e.g. three directional or spot light sources 5a and a diffuse light source 5b.

The directional light sources 5a of the chandelier 20 may be constituted for example by LEDs, in order to emit light directionally, and the diffuse light 5b is generated an array of stripped optical fibers, i.e. with transparent sheathing, thus enabling the space 7 to be illuminated substantially uniformly.

Other light sources 5c and 5d are connected to control modules 4 connected by remote connections 11 to the base module 3, e.g. by PLC connections.

By way of example, the light source 5c comprises a halogen lamp, and the light source 5d comprises an incandescent lamp. The light source 5c is connected to a control module 4 (not visible), itself being connected in this example via a PLC connection to the base module 3.

As shown, the space 7 may optionally include an image projection device, e.g. a video screen 6. The screen may optionally be associated with a control module that enables it to be switched on or off, and/or that enables an image or a predefined sequence of images to be displayed.

Once initialized in the manner explained below, the interactive system 4 shown in FIGS. 1 and 2 may operate as follows.

When a person P enters the space 7, the video camera 2 obverses that entry, and the base module 3 analyzes the image and determines the spatial coordinates of the person P in two dimensions (x,y), or indeed in the three-dimensions (x,y,z) if at least two or more cameras are being used.

In order to determine the coordinates of one or more people, the interactive system may operate as follows. A first image may be acquired by the video camera 2. The base module 3 may define the background image, e.g. by the method of Grimson et al. A second image or current image is acquired. The difference image between the second image and the first image is computed. The background image may then be updated by the method of Grimson et al. (see the publication: An improved adaptive background mixed model for real-time tracking with shadow detection, Proc. 2nd European Workshop on Advanced Video Based Surveillance Systems, AVBS01, September 2001, Video Based Surveillance Systems; Computer Vision and Distributed Processing, Kluwer Academic Publishers).

The difference image may then be filtered. The “foreground” pixels that do not form part of the background image may be grouped together into sets of connected pixels known as “blobs”. Thereafter the position of the center of gravity of said blobs can be measured and filtered, e.g. using a Kalman filter, so as to determine the coordinates and thus the position of the or each person. The steps of acquiring the second image up to measuring the position of the center of gravity may be reiterated throughout the duration the system is in operation.

After the information transmitted by the video camera 2 has been analyzed and processed, the base module 3 can cause one or more light sources 5 to be switched on by sending a control signal to the control module 4, thereby implementing a predefined lighting relationship. The relationship may take account of the activity of the people, as determined by the system as a function of the movements it detects and also the light intensity associated with any natural light and with existing light sources, as described below with reference to FIG. 4.

By way of example, the base module 3 may act via the associated control module 4 to set the intensity of the diffuse light source 5 as a function of the ambient lighting associated with natural light.

The base module 3 may also send control signals to cause the light sources 5c and 5d to be switched on. Assuming that the person P sits down in a chair, as shown, the base module 3 calculates the new coordinates of the person P and, after a predefined duration, determines that the person is no longer moving. Then, in application of a predefined lighting relationship, the base module 3 may for example limit lighting to the zone where the person is sitting.

The interactive system 1 may be initialized as follows, as shown in FIG. 3.

In a step 30, the interactive system 1 is installed, i.e. put into place and connected, in the space 7.

In a step 31, the interactive system 1 begins initialization by switching on a light source i and using the video camera in a step 32 to record the corresponding spatial distribution of light in the space 7 that results from the light source i.

Steps 31 and 32 are repeated for all of the control modules and the associated light sources. The corresponding information may be stored in a table.

While the system is being trained concerning the effect of each light source on the lighting of the associated space, the lighting of the light source may be controlled to take on its maximum level and then the light source may be switched off. In a variant, and where possible, for each source training may be performed using a plurality of light intensity levels.

In a step 33, the video camera 2 acquires one or more images that are transmitted to the base module 3.

In a step 34, the base module 3 analyses these images, and in a step 35, the base module determines the lighting level required from each of the sources in order to comply with a predefined lighting relationship as a function of this analysis.

In a step 36, the base module sends the corresponding control signals to the control modules 4 that act in a step 37 to power the light sources to the required intensity.

Steps 33 to 37 are repeated at a frequency that is high enough to impart the necessary reactivity to the interactive system.

FIG. 4 shows an example of how the analysis and the determination of the predefined lighting relationship takes place.

In this example, the base module 3 may be arranged in a step 40 to respond to the images received by the video camera 2 to determine information relating to the movements of the center of gravity of the or each person present in the space covered by the video camera(s), together with an indicator of the quantity of their movement.

Then, in a step 41, the base module 3 may be arranged to estimate the most probable activity of each person as a function of this information and of a database, and in particular the activity may be selected from generic activities such as eating, reading, sleeping, exercising, etc.

If several people are detected, the base module 3 may be arranged in a step 42 to compare the most probable activities of the people and to estimate a general activity that is taking place in the space, where appropriate, on the basis of the above-mentioned information and of a database. For example, it is more probable that two people will be eating a meal together than one of them will be eating while the other is exercising.

The base module 3 may be arranged in a step 43 to enter the activity in scenario logic with the help of a database. For example, it is more probable after a meeting, for several people to eat together than it is for them to take exercise.

In a step 44, the base module 3 may be configured to determine the best lighting, both overall and locally, as a function of the activity of the people in the space.

In a step 45, the interactive system may be configured to measure the ambient light level.

In a step 46, the base module 3 may be configured to determine the additional amount of light to be provided by the light sources and the intensity they are to have in order to achieve the best lighting determined in step 44, as a function of the light levels stored for each of the light sources during the above-described stage of initializing the system.

In a step 47, the base module 3 is arranged to send a control signal to the control module(s) 4.

These steps may be implemented at regular time intervals, for example.

The invention is not limited to the examples described above.

With reference to FIGS. 5 to 7 there follows a description of an interactive system 100 in another aspect of the invention.

The interactive system 100 has at least one light source 101, at least one camera 102, and at least one processor system 103 for processing the images delivered by the camera and for controlling the light source(s) 101 as a function of those images.

By way of example, the camera my be hidden behind a semi-reflective surface (not shown).

The processor system 103 is arranged in particular to detect the face of a person P in the field of observation of the camera 102, which field may be directed away from an object O, i.e. towards a possible observer of the object O.

The processor system 103 may for example implement the method described in the publication by P. Viola, M. Jones “Rapid object detection using a boosted cascade of simple features”, an implementation of which is available in the Open Source Computer Vision (OpenCV) Library published by Intel®.

The processor system 103 may implement a loop in which initially an image is acquired by the camera 102, and is then analyzed, with the lighting of the object O being modified depending on whether or not a face is detected in the image.

The processor system 103 may comprise a microcomputer or any other equivalent computer means. Lighting may be controlled via a specialized interface, for example lighting may be controlled via a PLC, RF, or infrared (IR) system.

For example, when a face is detected, the light intensity from the light sources 101 is incremented, e.g. progressively, and when no face is detected, the intensity is reduced progressively on each iteration of the processing loop.

In the example of FIG. 5, the object O illuminated by the interactive system 100 is a museum exhibit, e.g. a painting, and the processor system 103 includes a meter for measuring the duration of lighting.

In a variant that is not shown, the interactive processor system 100 also includes a screen, e.g. a flat screen of the LCD type and/or one or more loudspeakers, so that the modification to the lighting of the observed exhibit O is accompanied by the interactive system 100 playing back audiovisual content relating to said exhibit.

After detecting the presence of a face in the field of view of the camera, the processor system 103 may determine the direction in which the face is looking, e.g. that person's gaze direction.

FIG. 6 shows the lighting modification implemented by the interactive system 100 when the system detects a person's face and modifies the lighting of the object O accordingly.

FIG. 7 shows the situation in which the object of is not lighted since a person's face is no longer detected.

In another example that is not shown, the interactive system 100 is incorporated in a light fitting associated with the object, e.g. a wall-mounted fitting.

In another variant that is not shown, the object O is placed in a shop window or a home showcase.

The expression “comprising a” should be understood as being synonymous with the expression. “comprising at least one” unless specified to the contrary.

1. An interactive system (1) for controlling lighting and/or image playback, the system comprising:
at least one image acquisition device, in particular a video camera (2);
a base module (3) configured to receive and analyze information from the image acquisition device (2) in order to detect the presence of at least one person (P) in the field of the image acquisition device; and
at least one control module (4) configured to receive a control signal coming from the base module (3) and, as a function of said control signal, to control the intensity and/or the orientation of at least one light source (5) and/or at least one played-back visual content, in order to comply with a predefined lighting relationship;
the base module (3) being configured, at least while the system is initially being put into service, to cause the light sources (5) to be switched on in succession and to record the spatial distribution of the light intensity produced by each of said light sources (5).

2. An interactive system (1) for controlling lighting and/or image playback, the system comprising:
at least one image acquisition device, in particular a video camera (2);
a base module (3) configured to receive and analyze information from the image acquisition device (2) in order to detect the presence of at least one person (P) in the field of the image acquisition device; and
at least one control module (4) configured to receive a control signal coming from the base module (3) and, as a function of said control signal, to control the intensity and/or the orientation of at least one light source (5) and/or at least one played-back visual content, in order to comply with a predefined lighting relationship;
the image acquisition device, the base module, and one or more control modules being incorporated in a luminaire fitting, in particular a chandelier, and
the luminaire fitting including a light source (5b) providing diffuse lighting and at least two light sources (5a) providing directional lighting, each associated with a respective control module (4).

3. A system according to claim 1 or claim 2, wherein the base module (3) is configured to respond to the information coming from the image acquisition device (2) to determine the spatial coordinates of a person located in the field of said device (2).

4. A system according to any preceding claim, including at least one remote control module (4) communicating with the base module (3) by power line carrier.

5. A system according to any preceding claim, the image acquisition device (2) comprising a video camera having 360° vision.

6. A system according to any preceding claim, including a pyroelectric sensor.

7. A method of automatically modifying the lighting of a space (7) including at least one light source (5a) providing directional lighting and at least one light source (5b) providing diffuse lighting for lighting the space at least in part, the method comprising the steps consisting in:
acquiring at least one image of at least a portion of said space (7) suitable for being lighted at least by said light source (5);
analyzing said image to detect the presence of at least one person; and
as a function of the analysis as performed in this way, controlling the light source(s) (5) so as to comply with a predefined lighting relationship for said space governing the ratio between the level of lighting from the light source(s) (5a) providing directional lighting and the lighting provided by the light sources (5b) providing diffuse lighting.

8. A method according to the preceding claim, including the step consisting in analyzing said image to measure the light level of at least said portion of the space.

9. A method of initializing an interactive system as defined in any one of claims 1 to 6, used in association with a space including at least one light source, the method comprising the following steps:
a) installing the system;
b) switching on a light source;
c) using the image acquisition device, in particular the video camera, to determine the incidence on the light level of the space or switching on said light source, and storing corresponding information; and
d) reiterating steps b) and c) for any other light sources, where appropriate.

10. An interactive system (100) for lighting an object (O), the interactive system comprising:
one or more light sources (101) lighting the object (O);
a camera (102) having its field of view directed in a direction away from the object (O); and
a data processor system (103) for processing the data coming from the camera (102) and for controlling the light source(s) (101);
the processor system (103) being arranged to modify the lighting delivered by the light source(s) (101) as a function of detecting at least a portion of the face of a person (P) in the field of observation of the camera (102).

11. An interactive system according to claim 10, the modification to the lighting comprising:
switching on or off the light source(s) (101) controlled by the interactive system; and/or
changing the color of the light source(s) (101); and/or
increasing or decreasing the intensity of light provided by one or more of the light sources (101).

12. An interactive system according to claim 11, the lighting modification including switching the lighting intensity of the light sources (101) on or off in progressive manner.

13. An interactive system according to any one of claims 10 to 12, the analysis of the image from the camera (102) making it possible to detect the orientation of the face of the person (P), in particular the person's gaze direction.

14. An interactive system according to claim 13, being configured in such a manner as to modify the lighting from at least two light sources differently as a function of the detected orientation of the face.

15. An interactive system according to any one of claims 10 to 14, being arranged to cause audiovisual content to be played back in addition to modifying lighting, the content relating to the observed object.

16. An interactive system according to any one of claims 10 to 15, the camera (102) being hidden from observers of the object (O).

17. An interactive system according to any one of claims 10 to 16, including a meter for metering the duration of lighting.

18. An interactive system according to any one of claims 10 to 17, the system not including any means for bulk storage of the images picked up by the camera (102) nor any means for sending said images to a server.

19. An interactive system according to any one of claims 10 to 18, the system being incorporated in a fitting for lighting the object (O).

20. An interactive system according to any one of claims 10 to 19, the camera (102) being arranged to observe in visible light or in infrared light.

21. A method of automatically modifying the lighting of an object (O) lighted by at least one light source (101), in particular an object in a shop window, a showcase, or a museum, the method comprising the following steps:
acquiring an image by means of a camera (102) having its field of view directed in a direction away from the object (O);
detecting in the acquired image at least a portion of the face of a person (P); and
modifying the lighting of the source(s) (101) as a function of the detection performed in the preceding step.

22. A method according to claim 20, wherein the lighting is modified by:
switching on or off the light source(s) (101); and/or
changing the color of the light source(s) (101); and/or
increasing or decreasing the light intensity coming from one or more of the light sources (101).

23. A method according to claim 20 or claim 21, wherein the orientation of the face of the person (P) is detected.

24. A method according to any one of claims 20 to 22, wherein audiovisual content is issued in addition to modifying the lighting, the audiovisual content relating in particular to the observed object (O).

25. A method according to any one of claims 20 to 23, not including any step whereby images picked up by the camera are stored in bulk storage means or any step whereby said images are sent to a server.
